(19) United States
(12) Patent Application Publication
(10) Pub. No.: US 2019/0138144 A1
(43) Pub. Date: May 9, 2019

(54) TOUCH DEVICE AND TOUCH SIGNAL PROCESSING METHOD THEREOF

(71) Applicant: Chunghwa Picture Tubes, LTD., Taoyuan City (TW)

(72) Inventors: Chao-Wei Wei, Taoyuan City (TW); Chun-Chung Wu, Taoyuan City (TW); Kun-Chi Chiu, Miaoli County (TW)

(73) Assignee: Chunghwa Picture Tubes, LTD., Taoyuan City (TW)

(21) Appl. No.: 15/846,207

(22) Filed: Dec. 19, 2017

(30) Foreign Application Priority Data
Nov. 6, 2017 (CN) 201711076629.4

(51) Int. Cl. G06F 3/041; G06F 3/0354

(52) U.S. Cl. CPC G06F 3/0416; G06F 3/03545

(57) ABSTRACT

A touch device and a touch signal processing method thereof are provided. A type of a touch tool is determined according to a ratio between an average of signal intensities of sub touch signals of touch units in a target region and a signal intensity of a sub touch signal of a touch unit having the maximum signal intensity, and the touch signal is sharpened according to the type of the touch tool, so as to avoid interruption of the touch signal and misjudgment of a touch position due to inadequate intensity of sensing signals of the touch tool.

### CROSS-REFERENCE TO RELATED APPLICATION

This application claims the priority benefit of China application serial no. 201711076629.4, filed on Nov. 6, 2017. The entirety of the above-mentioned patent application is hereby incorporated by reference herein and made a part of this specification.

### BACKGROUND OF THE INVENTION

### Field of the Invention

The invention relates to an electronic device, and particularly relates to a touch device and a touch signal processing method thereof.

### Description of Related Art

Generally, a touch panel may not only support finger touch, but may also support a stylus to perform touch operations. When the stylus is applied to perform the touch operation, an intensity of a touch sensing signal of the stylus sensed by a touch panel is lower than an intensity of a touch sensing signal of a finger, and due to an influence of environmental noise, a touch trajectory of the stylus is easily broken due to the low intensity of the touch sensing signal or misjudgement of a touch position is liable to be occurred. Generally, the influence of the noise may be eliminated by using a median filter, and a main effect of the median filter is to reorder the dispersed noises in the signal for filtering, though such filtering method may result in intensity attenuation of the touch sensing signal.

### SUMMARY OF THE INVENTION

The invention is directed to a touch device and a touch signal processing method thereof, by which a type of a touch tool is effectively determined, and interruption of a touch signal and misjudgment of a touch position due to inadequate intensity of sensing signals of the touch tool are avoided.

An embodiment of the invention provides a touch device including a touch panel and a processing circuit. The touch panel receives a touch operation of a touch tool to generate a touch signal corresponding to the touch operation, wherein the touch signal includes a plurality of sub touch signals generated by a plurality of touch units in a touch region touched by the touch tool. The processing circuit is coupled to the touch panel, and calculates an average of signal intensities of the sub touch signals of the touch units in a target region, wherein a center of the target region is a touch unit having the maximum signal intensity within the touch region, the processing circuit determines a type of the touch tool according to a ratio between an average of signal intensities of the sub touch signals of the touch units located adjacent to the touch unit having the maximum signal intensity and a signal intensity of the sub touch signal of the touch unit having the maximum signal intensity.

In an embodiment of the invention, when the ratio is smaller than a predetermined ratio, the processing circuit determines that the touch tool is a stylus.

In an embodiment of the invention, the predetermined ratio is 2/3.

In an embodiment of the invention, when the touch tool is a stylus, the processing circuit further performs a sharpening processing to the touch signal according to the signal intensities of the sub touch signals produced by the touch units in the touch region in a current touch detection cycle and last N touch detection cycles, wherein N is a positive integer.

In an embodiment of the invention, when the touch tool is the stylus, the processing circuit multiplies the signal intensities of the sub touch signals produced by each of the touch units in the touch region in the current touch detection cycle and the last N touch detection cycles to sharpen the touch signal.

In an embodiment of the invention, the processing circuit further determines whether the touch signal is a noise signal according to an average of the signal intensities of the sub touch signals of each of the touch units in the touch region within a predetermined period.

An embodiment of the invention provides a touch signal processing method of a touch device, which include following steps: producing a touch signal corresponding to a touch operation of a touch tool on a touch panel, wherein the touch signal includes a plurality of sub touch signals generated by a plurality of touch units in a touch region touched by the touch tool; calculating an average of signal intensities of the sub touch signals of the touch units in a target region, wherein a center of the target region is a touch unit having the maximum signal intensity within the touch region; determining a type of the touch tool according to a ratio between an average of signal intensities of the sub touch signals of the touch units located adjacent to the touch unit having the maximum signal intensity and a signal intensity of the sub touch signal of the touch unit having the maximum signal intensity.

In an embodiment of the invention, when the ratio is smaller than a predetermined ratio, the touch tool is determined as a stylus.

In an embodiment of the invention, the predetermined ratio is 2/3.

In an embodiment of the invention, when the touch tool is a stylus, the touch signal processing method of the touch device further includes: performing a sharpening processing to the touch signal according to the signal intensities of the sub touch signals produced by the touch units in the touch region in a current touch detection cycle and last N touch detection cycles, wherein N is a positive integer.

In an embodiment of the invention, when the touch tool is the stylus, the touch signal processing method of the touch device further includes: multiplying the signal intensities of the sub touch signals produced by each of the touch units in the touch region in the current touch detection cycle and the last N touch detection cycles to sharpen the touch signal.

In an embodiment of the invention, the touch signal processing method of the touch device further includes: determining whether the touch signal is a noise signal according to an average of the signal intensities of the sub touch signals of each of the touch units in the touch region within a predetermined period.

According to the above description, in the embodiment of the invention, the type of the touch tool is determined according to the ratio between the average of the signal intensities of the sub touch signals of the touch units in the target region and the signal intensity of the sub touch signal of the touch unit having the maximum signal intensity, and the touch signal is sharpened according to the type of the touch tool, so as to avoid the interruption of the touch signal and misjudgment of a touch position due to inadequate intensity of sensing signals of the touch tool.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch device according to an embodiment of the invention.

FIG. 2A and FIG. 2B are schematic diagrams of calculating an average of signal intensities of output signals of touch units according to an embodiment of the invention.

FIG. 3A and FIG. 3B are schematic diagrams illustrating signal intensities of sub touch signals of a touch region according to an embodiment of the invention.

FIG. 4 is a schematic diagram of a sharpening processing of the touch signals according to an embodiment of the invention.

FIG. 5 is a flowchart illustrating a touch signal processing method of a touch device according to an embodiment of the invention.

FIG. 6 is a flowchart illustrating a touch signal processing method of a touch device according to another embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

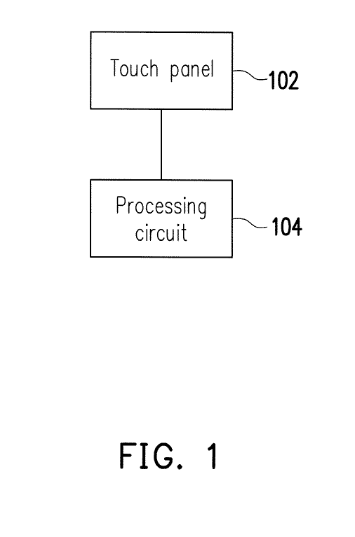

FIG. 1 is a schematic diagram of a touch device according to an embodiment of the invention. Referring to FIG. 1, the touch device may include a touch panel 102 and a processing circuit 104, where the touch device is, for example, a touch display device, and the touch panel is, for example, a capacitive touch panel or a touch display panel, though the invention is not limited thereto. The processing circuit 104 may include a central processor, or other programmable general purpose or special purpose microprocessor, a digital signal processor (DSP), a controller, an application specific integrated circuit (ASIC), a programmable logic device (PLD) or other similar devices or a combination of these devices. Moreover, the processing circuit 104 may be configured with a volatile storage medium such as a random access memory or a read-only memory, etc.

The touch panel 102 may receive a touch operation of a touch tool to generate a touch signal corresponding to the touch operation, where the touch tool is, for example, a finger or a stylus, though the invention is not limited thereto. The touch signal may include a plurality of sub touch signals generated by a plurality of touch units in a touch region touched by the touch tool, for example, in a capacitive touch panel, each of the touch units may be composed of a transistor and a corresponding touch sensing pad, and when the touch tool touches the touch panel 102, the touch tool may simultaneously contact a plurality of the touch units, and the touched touch units form the touch region, and the touched touch units may all produce the corresponding sub touch signals.

The processing circuit 104 is coupled to the touch panel 102, and the processing circuit 104 may calculate an average of signal intensities of the sub touch signals of the touch units in a target region, wherein a center of the target region is the touch unit having the maximum signal intensity within the touch region, namely, the target region is formed by the touch unit having the maximum signal intensity and the surrounding touch units in the touch region, and the target region is smaller than or equal to the touch region. The processing circuit 104 may determine a type of the touch tool according to a ratio between an average of signal intensities of the sub touch signals of the touch units located directly adjacent to the touch unit having the maximum signal intensity and a signal intensity of the sub touch signal of the touch unit having the maximum signal intensity.

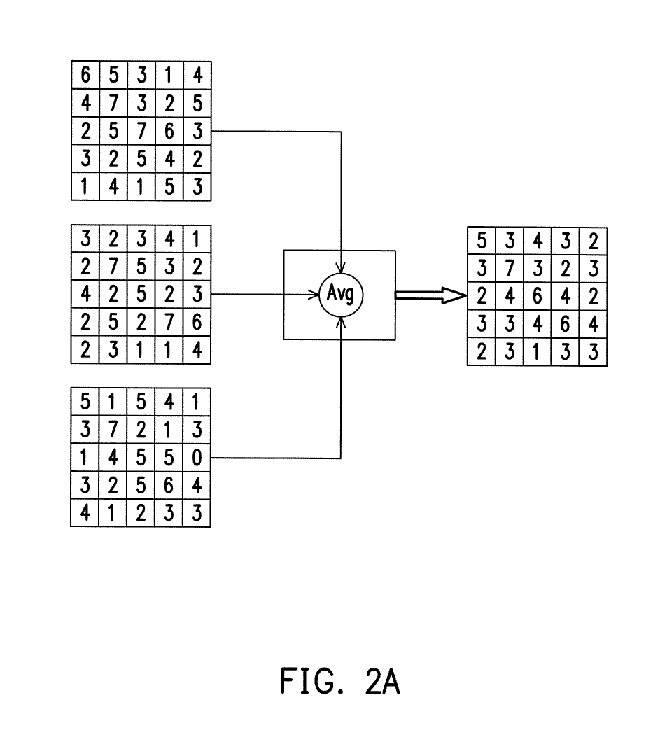

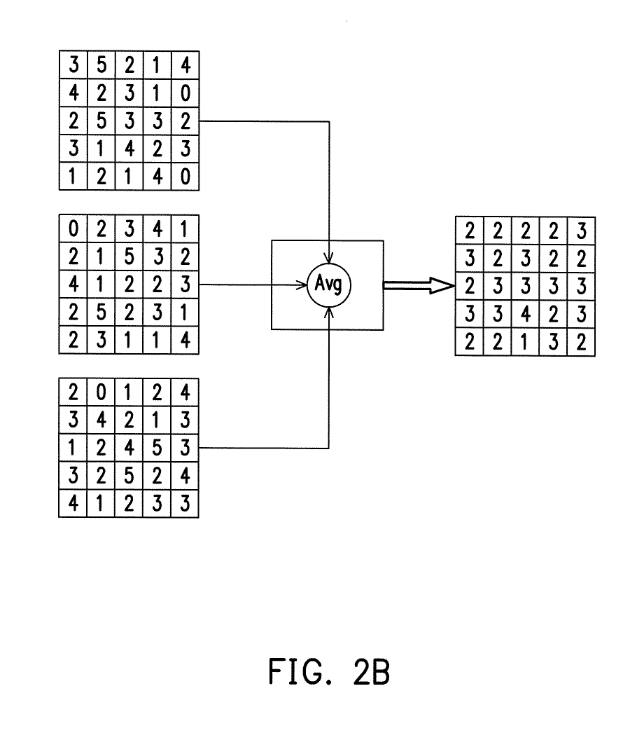

In detail, before determining the type of the touch tool, the processing circuit 104 may first determines whether the touch signal is a noise signal according to an average of signal intensities of signals output by each of the touch units in the touch region within a predetermined period. For example, FIG. 2A and FIG. 2B are schematic diagrams of calculating an average of the signal intensities of the output signals of the touch units according to an embodiment of the invention. In FIG. 2A and FIG. 2B, the processing circuit 104 calculates an average AVg on the signal intensities of the output signals of each of the touch units in the last three (not limited thereto) touch detection cycles (frames), and determines whether the output signals are noise signals according to the maximum signal intensity average and a predetermined threshold. For example, in FIG. 2A, the maximum signal intensity average of the touch units is 7, and it is assumed that the predetermined threshold is 5, the processing circuit 104 may determine that the signals output by the touch units in the touch region are touch signals and are not noise signals. In FIG. 2B, the maximum signal intensity average of the touch units is 4, which is smaller than the predetermined threshold 5, the processing circuit 104 may determine that the signals output by the touch units are noise signals, and subsequent determination of a touch position is not performed.

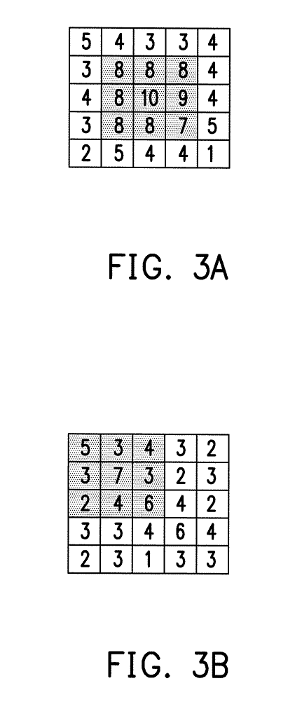

After determining that the signals output by the touch units are not noise signals, the processing circuit 104 may further determine the type of the touch tool. For example, FIG. 3A and FIG. 3B are schematic diagrams illustrating signal intensities of sub touch signals of the touch region according to an embodiment of the invention. In FIG. 3A, a signal intensity value of the sub touch signal having the maximum signal intensity is 10, and the target region may be composed of the touch unit with the signal intensity value of 10 and the touch units located directly adjacent to the touch unit with the signal intensity value of 10, and the processing circuit 104 calculates a signal intensity average of the sub touch signals of the touch units located adjacent to the touch unit having the maximum signal intensity in the target region, and calculates a ratio between signal intensity average the signal intensity and the signal intensity of the sub touch signal of the touch unit having the maximum signal intensity, and if the ratio is not smaller than a predetermined ratio, the processing circuit 104 may determine that the touch tool has a larger touch area, which is, for example, a finger. If the ratio is smaller than the predetermined ratio, the processing circuit 104 may determine that the touch tool has a smaller touch area, which is, for example, a stylus, where the predetermined ratio is, for example, 2/3, though the invention is not limited thereto.

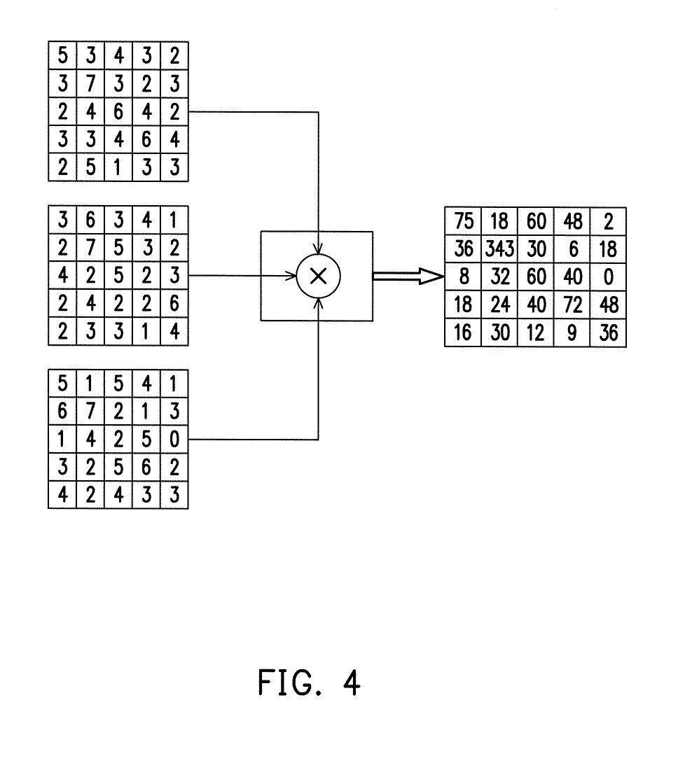

Moreover, when the touch tool is the stylus, the processing circuit 104 further performs a sharpening processing to the touch signal according to the signal intensities of the sub touch signals produced by the touch units in the touch region in a current touch detection cycle and last N touch detection cycles, wherein N is a positive integer. For example, FIG. 4 is a schematic diagram of a sharpening processing of the touch signals according to an embodiment of the invention. When the touch tool is the stylus, the processing circuit 104 may multiply the signal intensities of the sub touch signals produced by each of the touch units in the touch region in the current touch detection cycle and the last two touch detection cycles, where the signal intensity of the sub touch signal of the touch unit at the center of the touch region is increased due to the multiplication operation, and the signal intensities of the surrounding sub touch signals are much lower than the signal intensity of the touch unit at the center position after the multiplication operation due to instability of the signal intensities. In this way, the touch signal is sharpened to resolve the problems of inadequate signal intensity of the touch signal of the stylus and noise interference, such that the touch panel 102 is adapted to the stylus with a smaller tip width, which improves a touch resolution of the touch device, and the touch panel is adapted to execute a more precise touch operation without touch signal interruption, for example, the processing circuit 104 may control the touch panel 102 to display a more precise touch trajectory in response to the touch signals without touch trajectory broken.

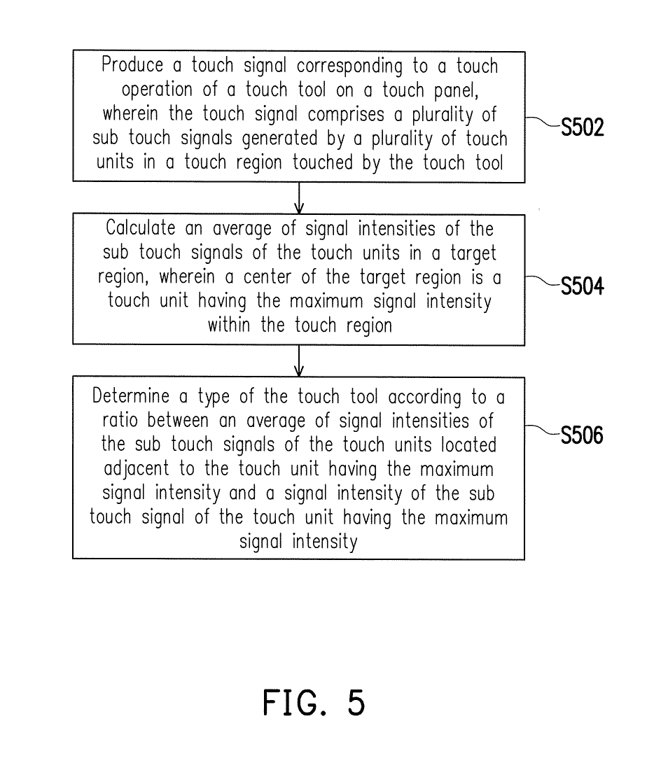

FIG. 5 is a flowchart illustrating a touch signal processing method of a touch device according to an embodiment of the invention. Referring to FIG. 5, according to the above embodiment, it is known that the touch signal processing method of the touch device may at least include following steps. First, a touch signal corresponding to a touch operation of a touch tool on a touch panel is produced, wherein the touch signal includes a plurality of sub touch signals generated by a plurality of touch units in a touch region touched by the touch tool (step S502), where the touch tool is, for example, a finger or a stylus, though the invention is not limited thereto. Then, an average of signal intensities of the sub touch signals of the touch units in a target region is calculated, wherein a center of the target region is a touch unit having the maximum signal intensity within the touch region (step S504). In some of the embodiments, the step S502 may include determining whether the touch signal is a noise signal according to an average of the signal intensities of the sub touch signals of each of the touch units in the touch region within a predetermined period, and when the touch signal is not the noise signal, a step S504 is executed. Then, a type of the touch tool is determined according to a ratio between an average of signal intensities of the sub touch signals of the touch units located adjacent to the touch unit having the maximum signal intensity and a signal intensity of the sub touch signal of the touch unit having the maximum signal intensity (step S506), for example, when the ratio is smaller than a predetermined ratio, it is determined that the touch tool is a stylus, and when the ratio is not smaller than the predetermined ratio, it is determined that the touch tool is a finger.

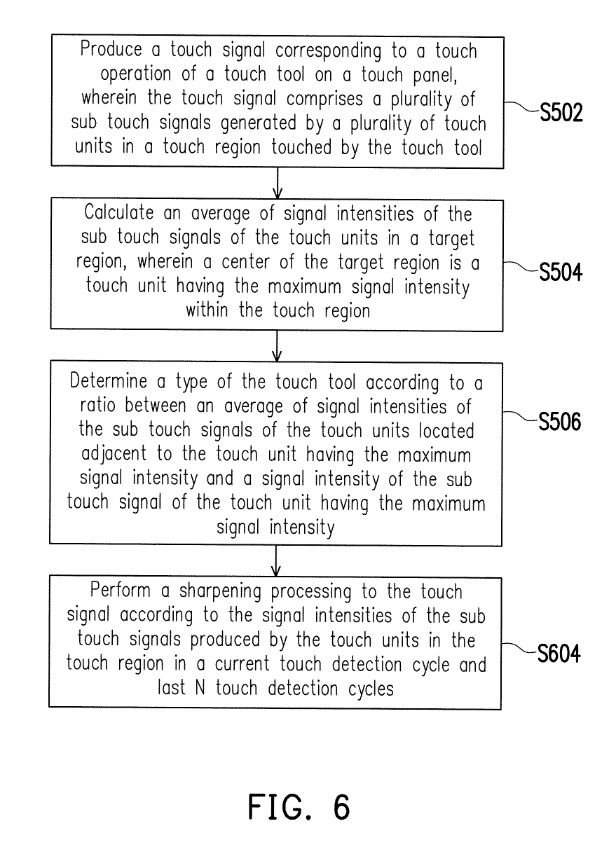

FIG. 6 is a flowchart illustrating a touch signal processing method of a touch device according to another embodiment of the invention. Referring to FIG. 6, in the present embodiment, the touch signal processing method of the touch device further includes a step S604, where after it is determined that the touch tool belongs to the type (for example, the stylus) requiring a sharpening processing in the step S506, in the step S604, a sharpening processing is performed to the touch signal according to the signal intensities of the sub touch signals produced by the touch units in the touch region in a current touch detection cycle and last N touch detection cycles, wherein N is a positive integer. For example, the signal intensities of the sub touch signals produced by the touch units in the touch region in the current touch detection cycle and the last N touch detection cycles may be multiplied to sharpen the touch signal.

In summary, in the embodiment of the invention, the type of the touch tool is determined according to the ratio between the average of the signal intensities of the sub touch signals of the touch units in the target region and the signal intensity of the sub touch signal of the touch unit having the maximum signal intensity, and the touch signal is sharpened according to the type of the touch tool, so as to avoid the interruption of the touch signal and misjudgment of a touch position due to inadequate intensity of sensing signals of the touch tool. In this way, the touch panel is adapted to the stylus with a smaller tip width, which improves a touch resolution of the touch device, and the touch panel is adapted to execute a more precise touch operation.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch device, comprising:
a touch panel, receiving a touch operation of a touch tool to generate a touch signal corresponding to the touch operation, wherein the touch signal comprises a plurality of sub touch signals generated by a plurality of touch units in a touch region touched by the touch tool; and
a processing circuit, coupled to the touch panel, and calculating an average of signal intensities of the sub touch signals of the touch units in a target region, wherein a center of the target region is a touch unit having the maximum signal intensity within the touch region, the processing circuit determines a type of the touch tool according to a ratio between an average of signal intensities of the sub touch signals of the touch units located adjacent to the touch unit having the maximum signal intensity and a signal intensity of the sub touch signal of the touch unit having the maximum signal intensity.

2. The touch device as claimed in claim 1, wherein when the ratio is smaller than a predetermined ratio, the processing circuit determines that the touch tool is a stylus.

3. The touch device as claimed in claim 2, wherein the predetermined ratio is 2/3.

4. The touch device as claimed in claim 1, wherein when the touch tool is a stylus, the processing circuit further performs a sharpening processing to the touch signal according to the signal intensities of the sub touch signals produced by the touch units in the touch region in a current touch detection cycle and last N touch detection cycles, wherein N is a positive integer.

5. The touch device as claimed in claim 4, wherein when the touch tool is the stylus, the processing circuit multiplies the signal intensities of the sub touch signals produced by each of the touch units in the touch region in the current touch detection cycle and the last N touch detection cycles to sharpen the touch signal.

6. The touch device as claimed in claim 1, wherein the processing circuit further determines whether the touch signal is a noise signal according to an average of the signal intensities of the sub touch signals of each of the touch units in the touch region within a predetermined period.

7. A touch signal processing method of a touch device, wherein the touch device comprises a touch panel, the touch signal processing method of the touch device comprising:
producing a touch signal corresponding to a touch operation of a touch tool on a touch panel, wherein the touch signal comprises a plurality of sub touch signals generated by a plurality of touch units in a touch region touched by the touch tool;
calculating an average of signal intensities of the sub touch signals of the touch units in a target region, wherein a center of the target region is a touch unit having the maximum signal intensity within the touch region;
determining a type of the touch tool according to a ratio between an average of signal intensities of the sub touch signals of the touch units located adjacent to the touch unit having the maximum signal intensity and a signal intensity of the sub touch signal of the touch unit having the maximum signal intensity.

8. The touch signal processing method of the touch device as claimed in claim 7, wherein when the ratio is smaller than a predetermined ratio, the touch tool is determined as a stylus.

9. The touch signal processing method of the touch device as claimed in claim 8, wherein the predetermined ratio is 2/3.

10. The touch signal processing method of the touch device as claimed in claim 7, wherein when the touch tool is a stylus, the touch signal processing method of the touch device comprises:
performing a sharpening processing to the touch signal according to the signal intensities of the sub touch signals produced by the touch units in the touch region in a current touch detection cycle and last N touch detection cycles, wherein N is a positive integer.

11. The touch signal processing method of the touch device as claimed in claim 10, wherein when the touch tool is the stylus, the touch signal processing method of the touch device comprises:
multiplying the signal intensities of the sub touch signals produced by each of the touch units in the touch region in the current touch detection cycle and the last N touch detection cycles to sharpen the touch signal.

12. The touch signal processing method of the touch device as claimed in claim 10, further comprising:
determining whether the touch signal is a noise signal according to an average of the signal intensities of the sub touch signals of each of the touch units in the touch region within a predetermined period.
